(19) United States
(12) Patent Application Publication
(10) Pub. No.: US 2018/0057405 A1
(43) Pub. Date: Mar. 1, 2018

(54) PRINTABLE CONCRETE COMPOSITION

(71) Applicant: United States of America as Represented by The Secretary of The Army, Alexandria, VA (US)

(72) Inventors: Ghassan Al-Chaar, Champaign, IL (US); Michael Patrick Case, Mahomet, IL (US); Gerald R. Northrup, Champaign, IL (US); Megan A. Kreiger, Champaign, IL (US); Bruce A. MacAllister, Mahomet, IL (US); William Jacob Wagner, Champaign, IL (US)

(21) Appl. No.: 15/382,421

(22) Filed: Dec. 16, 2016

Related U.S. Application Data
(63) Continuation-in-part of application No. 15/249,739, filed on Aug. 29, 2016.

(51) Int. Cl. C04B 18/14; C04B 28/18; C04B 14/10; C04B 18/08; C04B 16/12

(52) U.S. Cl. CPC C04B 18/146; C04B 28/18; C04B 16/12; C04B 18/08; C04B 14/104

(57) ABSTRACT

A printable concrete composition is made from the combination of a solid mix, water, and various liquid admixtures. The solid mix includes quantities of aggregate, coarse sand, and fine sand in an approximately 1:1:1 critical aggregate ratio, as well as a binding agent present in a critical binding ratio. Solid admixtures include clay, fly ash, and silica fume. This solid mix may be prepackaged for later combination with the water and liquid admixtures. The solid mix combines with water at a critical water ratio ranging from approximately 0.44 to approximately 0.50. Liquid admixtures include flow control, plasticizer, and shrinkage-reducing admixtures. Once the printable concrete composition is prepared, a user may print a structure without further modification of the composition. Users may embed mesh between layers of the printable concrete composition to reinforce or stabilize the structure.

### CROSS-REFERENCE TO RELATED APPLICATIONS

This application is a continuation-in-part and claims the benefit of U.S. patent application Ser. No. 15/249,739 filed Aug. 29, 2016. The above application is incorporated by reference herein in its entirety.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of concrete building material and more specifically to a concrete building material adapted for use in three-dimensional printing.

### BACKGROUND OF THE INVENTION

The U.S. Army Corps of Engineers (USACE) is at the forefront of developing 3D printing technologies for rapid construction of buildings for a range of military, humanitarian, and civilian operations consistent with its mission. USACE has developed 3D printing equipment specially scaled and adapted for this use.

However, a significant limiting factor for 3D construction projects has been the requirement to construct buildings of concrete rather than cement. Concrete is a building material among the strongest and most economical building materials known that is no-homogenous in nature. However, concrete derives its strength from the presence of “aggregate” of rocks and stone. Because of its non-homogeneous composition, concrete is not readily adapted for spraying and distribution by relatively sensitive, calibrated equipment.

Cement is a homogeneous mixture that does not clog machinery, but does not have the structural strength required to ensure buildings will not collapse under stress. Attempts have been made in the art to add controlled amounts of aggregate to cement paste. However, the increased viscosity of the cement paste, when combined with even a small amount of aggregate, adversely impacted the equipment and produced inconsistent results.

Attempts have also been made in the art to alter the properties of concrete to adapt it for use in spraying equipment. Additives to improve a particular property have adversely impacted other properties of the concrete which are also necessary to produce a stable 3D building structure. For example, a plasticizer increases flow, but delays the time for concrete to set and decreases strength. Adding clay can speed the set time, but also negates the increase in flow. Silica adds strength, but adversely impacts flow.

There is unmet need in the art for a concrete building printing material which can be successfully be used in 3D printing processes.

### BRIEF SUMMARY OF THE INVENTION

The present invention is a printable concrete composition made from the combination of a solid mix, water, and various liquid admixtures. The solid mix includes quantities of aggregate, coarse sand, and fine sand in an approximately 1:1:1 critical aggregate ratio, as well as a binding agent present in a critical binding ratio. Solid admixtures include clay, fly ash, and silica fume. This solid mix may be prepackaged for later combination with the water and liquid admixtures. The solid mix combines with water at a critical water ratio ranging from approximately 0.44 to approximately 0.50. Liquid admixtures include flow control, plasticizer, and shrinkage-reducing admixtures. Once the printable concrete composition is prepared, a user may print a structure without further modification of the composition. Users may embed mesh between layers of the printable concrete composition to reinforce or stabilize the structure.

### BRIEF DESCRIPTION OF SEVERAL VIEWS OF THE DRAWING(S)

FIG. 1 illustrates the components of an exemplary embodiment of a printable concrete composition.

FIGS. 2a and 2b illustrate top and side views, respectively, of an exemplary embodiment of a three-dimensional printed structure fabricated from the printable concrete composition.

### TERMS OF ART

As used herein, the term “accelerator admixture” refers to a sodium-, amine-, or calcium-based additive which decreases the set time and increases the strength of a composition.

As used herein, the term “admixture” refers to any ingredient which makes up less than 7.5% of the composition.

As used herein, the term “aggregate” means any additive, solid structures which add strength to a composition including stone, plastic, and regolith.

As used herein, the term “binding agent” refers to any binding agent including but not limited to cement for an aggregate, and may include lime and silicates in any effective ratio or binding.

As used herein, the term “coarse sand” refers to sand having at least 50% of the grains between 0.6 and 0.15 mm.

As used herein, the term “critical aggregate ratio” refers to the amount of aggregate relative the amounts of coarse and fine sand in a composition.

As used herein, the term “critical binding ratio” refers to the amount of binding agent relative to the amounts of aggregate and coarse and fine sand in a composition.

As used herein, the term “critical water ratio” refers to the ratio of dry ingredients to water.

As used herein, the term “fine sand” refers to sand having at least 90% of the grains between 0.6 and 0.15 mm.

As used herein, the term “flow control admixture” refers to a polymer-based additive which controls the rheology of a composition.

As used herein, the term “fly ash” refers to particles of coal combustion by-products.

As used herein, the term “plasticizer admixture” refers to an organic compound-based additive which produces or promotes flexibility and/or reduces brittleness of a composition.

As used herein, the term “shrinkage-reducing admixture” refers to an additive based on oxirane which reduces composition cracking and shrinkage during drying.

### DETAILED DESCRIPTION OF THE INVENTION

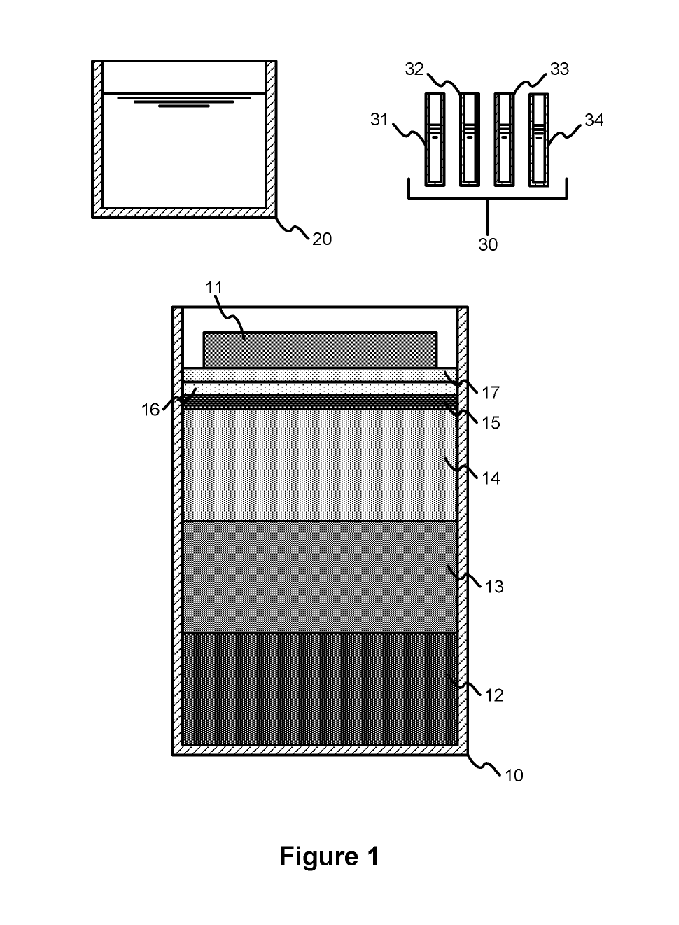

FIG. 1 illustrates the components of an exemplary embodiment of printable concrete composition 100. Printable concrete composition 100 is made from a combination of a solid mix 10, water 20, and at least one liquid admixture 30. Solid mix 10 and water 20 are combined at a ratio ranging from approximately 0.44 to approximately 0.50. As used herein, use of the term “ratios” refers to weight ratios unless otherwise noted. Due to the amount of water and the materials used, printable concrete composition 100 has a viscosity of between approximately 20 and approximately 50 Pa at 0.2 revolutions per minute.

Solid mix 10 is made up of all solid, i.e., non-liquid, components of printable concrete composition 100. Solid mix 10 may be produced, packaged for sale and/or transport, and combined with water 20 and liquid admixture 30 on-site to form printable concrete composition 100.

Solid mix 10 includes quantities of binding agent 11, aggregate 12, coarse sand 13, fine sand 14, a clay admixture 15, a fly ash admixture 16, and a silica fume admixture 17. In the exemplary embodiment, binding agent 11 is present in a critical binding ratio of approximately 0.8. Aggregate 12, coarse sand 13, and fine sand 14 are present in substantially equal proportions forming a critical aggregate ratio. In the exemplary embodiment, this critical aggregate ratio is approximately 1:1:1.

Clay admixture 15 is present in amounts ranging from approximately 1.25% to approximately 1.75% of solid mix 10. Fly ash admixture 16 is present in amounts ranging from approximately 7.5% to approximately 12.5% of solid mix 10. Silica fume admixture 17 is present in amounts ranging from approximately 3.75% to approximately 6.25% of solid mix 10.

In the exemplary embodiment, aggregate 12 is a quantity of gravel stones with a maximum size 0.375 inch in diameter. In certain embodiments, aggregate 12 is rounded gravel with a minimum of one fractured face. In the exemplary embodiment, clay admixture 15 is a bentonite clay used to reduce flowability, reduce the set time for printable concrete composition 100 after printing, and reduce shrinkage of printable concrete composition 100 during drying. In the exemplary embodiment, fly ash admixture 16 is a class-C fly ash which increases flowability, improves the long-term durability of structures made with printable concrete composition 100, and provides a cost-reducing filler. In the exemplary embodiment, silica fume admixture 17 is a condensed amorphous silica fume used to reduce flowability, reduce the set time for printable concrete composition 100 after printing, and improve the long-term strength and durability of structures made with printable concrete composition 100.

Liquid admixture 30 includes a flow control admixture 31, a plasticizer admixture 32, a shrinkage reducing admixture 33, and, optionally, an accelerator admixture 34.

Flow control admixture 31 is added to printable concrete composition 100 in amounts ranging from approximately 400 mL/100 kg of binding agent 11 to approximately 600 mL/100 kg of binding agent 11. Flow control admixture 31 controls the rheology of printable concrete composition 100 by altering its viscosity. This improves the flow and pumping of printable concrete composition 100 at high pressures. In the exemplary embodiment, flow control admixture 31 is a composition based on a water-soluble polymer.

Plasticizer admixture 32 is added to printable concrete composition 100 in amounts ranging from approximately 450 mL/100 kg of binding agent 11 to approximately 750 mL/100 kg of binding agent 11. Plasticizer admixture 32 allows a reduction in the amount of water 20 used in printable concrete composition 100, by increasing dispersion of the components of printable concrete composition 100 at lower levels of water 20. This improves the flow of printable concrete composition 100. In the exemplary embodiment, plasticizer admixture 32 is a naphthalene-based plasticizer without added chlorides.

Shrinkage reducing admixture 33 is present in amounts ranging from approximately 0.75 gal./yd³ to approximately 1.25 gal./yd³ of printable concrete composition 100. Shrinkage reducing admixture 33 reduces cracking and shrinkage during drying by reducing the capillary tension of water 20. In the exemplary embodiment, shrinkage reducing admixture 33 is a composition based on oxirane, methyl-, polymer with oxirane, monobutyl ether.

Accelerator admixture 34 is present in amounts ranging from approximately 625 mL/100 kg of binding agent 11 to approximately 875 mL/100 kg of binding agent 11. Accelerator admixture 34 decreases the set time and increases the strength of printable concrete composition 100. In one embodiment, accelerator admixture 34 is a non-chloride accelerator. In the exemplary embodiment, accelerator admixture 34 is a composition based on calcium nitrate, sodium thiocyanate, tetramethylolacethylenediurea, and formaldehyde.

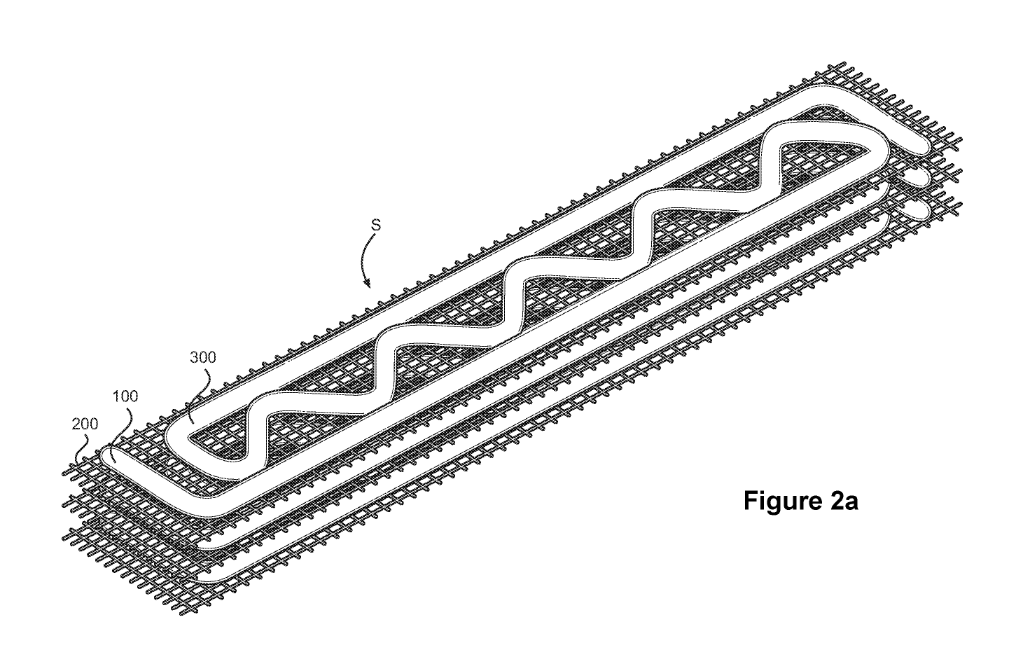

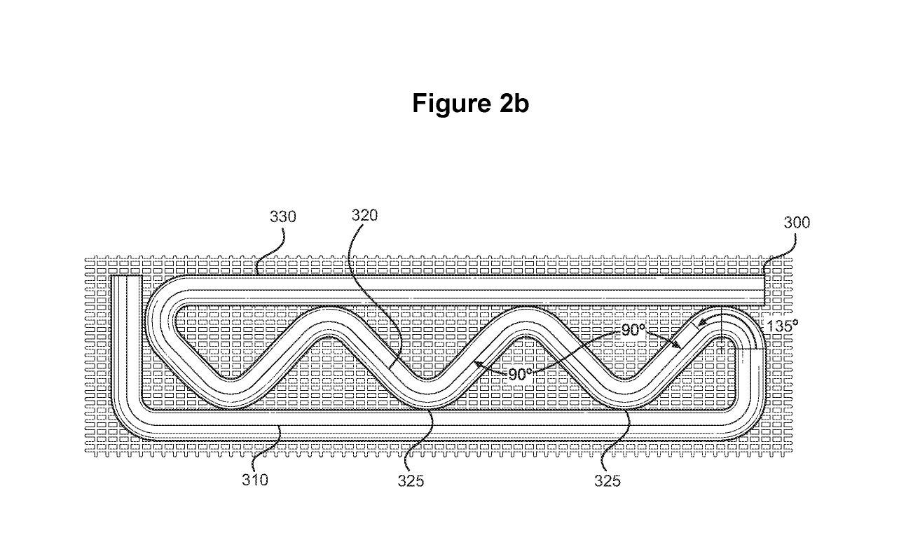

FIGS. 2a and 2b illustrate top and side views, respectively, of an exemplary embodiment of three-dimensional printed structure S fabricated from printable concrete composition 100. In certain embodiments, three-dimensional printed structure S can be formed by printing multiple stacked layers of continuous patterns 300 using printable concrete composition 100. In certain embodiments, a mesh 200 may be embedded between continuous patterns 300 to provide additional strength and/or stability. This mesh may be a polymer mesh reinforced with additional fibers. Such fibers may include aramid fibers, basalt fibers, fiber glass, and carbon fibers.

In the embodiment shown, continuous pattern 300 includes a U-shaped segment 310 joined by a periodic waveform segment 320 to a linear segment 330. Each peak 325 of the waveform contacts either U-shaped segment 310 or linear segment 330 to provide infill and reinforcement. In the exemplary embodiment, peaks 325 form an angle of approximately 90 degrees. A first end of U-shaped segment 310 is contiguous with a first end of periodic waveform segment 320. In the exemplary embodiment, the first end of periodic waveform segment 320 forms an angle of approximately 135 degrees with the first end of U-shaped segment 310. A first end of linear segment 330 is contiguous with a second end of periodic waveform segment 320.

It will be understood that many additional changes in the details, materials, procedures and arrangement of parts, which have been herein described and illustrated to explain the nature of the invention, may be made by those skilled in the art within the principle and scope of the invention as expressed in the appended claims. Moreover, the terms “about,” “substantially” or “approximately” as used herein may be applied to modify any quantitative representation that could permissibly vary without resulting in a change in the basic function to which it is related.

It should be further understood that the drawings are not necessarily to scale; instead, emphasis has been placed upon illustrating the principles of the invention.

What is claimed is:

1. A printable concrete composition, comprising:
a solid mix of coarse sand, fine sand, aggregate, and binding agent,
wherein said coarse sand, fine sand, and aggregate are present in substantially equal proportions forming a critical aggregate ratio,
wherein said binding agent is present in a critical binding ratio resulting in a viscosity between approximately 20 Pa and approximately 50 Pa at 0.2 revolutions per minute when water is added at a critical water ratio;
a clay admixture;
a fly ash admixture;
a silica fume admixture;
a flow control admixture;
a plasticizer admixture; and
a shrinkage-reducing admixture

2. The composition of claim 1, wherein said critical aggregate ratio of coarse sand to fine sand to aggregate is approximately 1:1:1.

3. The composition of claim 1, wherein said critical binding ratio is approximately 0.8.

4. The composition of claim 1, wherein said solid mix and said water form said critical water ratio ranging from approximately 0.44 to approximately 0.50.

5. The composition of claim 1, wherein said aggregate has a maximum size of approximately 0.375 inches.

6. The composition of claim 1, wherein said clay admixture is a bentonite clay admixture.

7. The composition of claim 1, wherein said clay admixture is present in amounts ranging from approximately 1.25% to approximately 1.75% of said solid mix.

8. The composition of claim 1, wherein said fly ash admixture is a class-C fly ash.

9. The composition of claim 1, wherein said fly ash admixture is present in amounts ranging from approximately 7.5% to approximately 12.5% of said solid mix.

10. The composition of claim 1, wherein said silica fume admixture is a condensed amorphous silica fume.

11. The composition of claim 1, wherein said silica fume admixture is present in amounts ranging from approximately 3.75% to approximately 6.25% of said solid mix.

12. The composition of claim 1, wherein said flow control admixture is present in amounts ranging from approximately 400 mL/100 kg to approximately 600 mL/100 kg of said binding agent.

13. The composition of claim 1, wherein said plasticizer admixture is present in amounts ranging from approximately 450 mL/100 kg to approximately 750 mL/100 kg of said binding agent.

14. The composition of claim 1, wherein said shrinkage-reducing admixture is present in amounts ranging from approximately 0.75 gal./yd³ to approximately 1.25 gal./yd³ of said printable concrete composition.

15. The composition of claim 1, wherein said composition further includes an accelerator admixture.

16. The composition of claim 15, wherein said accelerator admixture is a non-chloride accelerator.

17. The composition of claim 15, wherein said accelerator admixture is present in amounts ranging from approximately 625 mL/100 kg to approximately 875 mL/100 kg of said binding agent.

18. The composition of claim 1, further comprising a mesh embedded in said printable concrete composition.

19. The composition of claim 18, wherein said mesh is a polymer mesh reinforced by a plurality of fibers selected from the group consisting of: aramid fibers, basalt fibers, fiber glass, and carbon fibers.

20. The composition of claim 1, wherein said printable concrete composition forms a continuous pattern including a U-shaped segment joined to a linear segment by a periodic waveform segment such that a first end of said U-shaped segment is contiguous with a first end of said periodic waveform segment and a first end of said linear segment is contiguous with a second end of said periodic waveform segment.
